(19) United States
(12) Patent Application Publication
(10) Pub. No.: US 2026/0028019 A1
(43) Pub. Date: Jan. 29, 2026

(54) VEHICLE CONTROL DEVICE AND METHOD

(71) Applicant: HL MANDO CORPORATION, Pyeongtaek-si (KR)

(72) Inventor: Jun Hyung KIM, Pyeongtaek-si (KR)

(73) Assignee: HL MANDO CORPORATION, Pyeongtaek-si (KR)

(21) Appl. No.: 19/051,929

(22) Filed: Feb. 12, 2025

(30) Foreign Application Priority Data
Jul. 23, 2024 (KR) 10-2024-0097394

(51) Int. Cl. B60W 30/09; B60W 10/18; B60W 10/20

(52) U.S. Cl. CPC B60W 30/09; B60W 10/18; B60W 10/20; B60W 2520/14; B60W 2530/20

(57) ABSTRACT

The disclosure relates to a device and method for controlling a vehicle. Specifically, a vehicle control device according to the disclosure comprises a detector configured to detect a frictional force between a road surface on which a host vehicle is driving and a tire, a producer configured to produce a jerk plan for reaching a target location of the host vehicle based on a lateral jerk and a lateral acceleration of the host vehicle corresponding to the frictional force, and a controller configured to output a control signal to each actuator of the host vehicle, to move the host vehicle based on the jerk plan.

### CROSS-REFERENCE TO RELATED APPLICATION

This application claims priority from Korean Patent Application No. 10-2024-0097394, filed on Jul. 23, 2024, which is hereby incorporated by reference for all purposes as if fully set forth herein.

### BACKGROUND

### Field

Embodiments relate to a device and method for controlling a vehicle.

### Description of Related Art

Advanced driving assistance system (ADAS) is a state-of-the-art driver assistance system that enhances vehicle safety and driving convenience. It is a system that senses the circumstance ahead, judges the circumstance based on the sensed results, and controls the vehicle's movement based on the judgment of the circumstance.

For example, ADAS sensor devices detect vehicles ahead and recognize lanes. If the target lane, target velocity, and the target ahead are determined, it controls, e.g., the electrical stability control (ESC), engine management system (EMS), and motor driven power steering (MDPS).

For example, ADAS may be implemented as an automatic parking system, a low-speed city driving assistance system, and a blind spot warning system.

Interest in chassis integration control is increasing as computing performance enhances and more cars equipped with ADAS functions appear on the market.

In conventional chassis control, due to limitations in computing performance, it is common to use it to control specific states in each chassis device, such as the steering device, braking device, and suspension.

Here, as computing performance has enhanced, it has become possible to control each actuator simultaneously to achieve the desired performance, making it possible to enhance the turning capability of the vehicle by mutually compensating for actuator limitations beyond the turning capability through a single actuator as conventional.

Further, as ADAS makes it possible to consider not only the driver's steering intention but also the information about surrounding vehicles and nearby road conditions, there is a demand to provide the driver with a range of vehicle movement that takes all of such information into account.

### BRIEF SUMMARY

In the foregoing background, the disclosure provides a vehicle control device and method that provides a movement range of a vehicle driving to a target location by producing a jerk plan limiting the size of the jerk.

To achieve the foregoing objectives, in an aspect, the disclosure provides a vehicle control device comprising a detector configured to detect a frictional force between a road surface on which a host vehicle is driving and a tire, a producer configured to produce a jerk plan for reaching a target location of the host vehicle based on a lateral jerk and a lateral acceleration of the host vehicle corresponding to the frictional force, and a controller configured to output a control signal to each actuator of the host vehicle, to move the host vehicle based on the jerk plan.

In another aspect, the disclosure provides a vehicle control method comprising detecting a frictional force between a road surface on which a host vehicle is driving and a tire, producing a jerk plan for reaching a target location of the host vehicle based on a lateral jerk and a lateral acceleration of the host vehicle corresponding to the frictional force, and outputting a control signal to each actuator of the host vehicle, to move the host vehicle based on the jerk plan.

As described above, according to the disclosure, the vehicle control device and method may provide an optimal path and movement of a vehicle to reach a target location and prevent impossible vehicle movement by calculating a reference yaw rate.

Further, the disclosure may provide a high turning capability considering a limit performance of each actuator in producing a path, by calculating a reference yaw rate where ADAS information may be effectively utilized in integrated control beyond the conventional single actuator.

Further, it is possible to apply a desired turning radius to the vehicle path to reach a target location by making a reference yaw rate after setting a reference value, rather than a method of setting a reference value after generating a reference yaw rate as conventional.

### DESCRIPTION OF DRAWINGS

The above and other objects, features, and advantages of the disclosure will be more clearly understood from the following detailed description, taken in conjunction with the accompanying drawings, in which:

FIG. 1 is a block diagram schematically illustrating a vehicle control device according to an embodiment of the disclosure;

FIG. 2 is a view illustrating a jerk plan according to an embodiment;

FIG. 3 is a view illustrating a lateral acceleration that varies depending on tire types according to an embodiment;

FIG. 4 is a block diagram illustrating a vehicle control device according to another embodiment of the disclosure;

FIG. 5 is a flowchart illustrating a vehicle control method according to an embodiment of the disclosure; and

FIG. 6 is a flowchart illustrating, in greater detail, step S520 according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

A vehicle control device is described below with reference to the accompanying drawings.

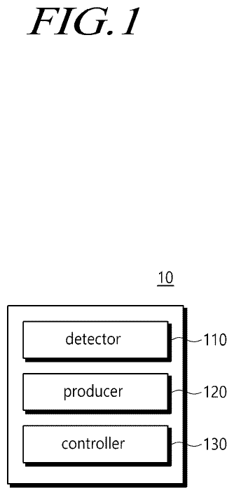

FIG. 1 is a block diagram schematically illustrating a vehicle control device 10 according to an embodiment of the disclosure.

Referring to FIG. 1, a vehicle control device 10 according to an embodiment of the disclosure may include a detector 110, a producer 120, and a controller 130.

The vehicle control device 10 according to the disclosure may detect a frictional force between a road surface on which a host vehicle is driving and a tire, produce a jerk plan for reaching a target location of the host vehicle based on a lateral jerk and a lateral acceleration of the host vehicle corresponding to the frictional force, and output a control signal to each actuator to move the host vehicle based on the jerk plan.

In an embodiment, the vehicle control device 10 may be implemented as a domain control unit (DCU).

The DCU may be a central control device equipped in the host vehicle to control and adjust various functions.

The DCU may integrate and control several sub systems in the host vehicle, thereby enhancing efficiency and performance.

The vehicle control device 10 may be an advance driver assistance systems (ADAS) that provides information for assisting driving of the vehicle or provides assistance for controlling the vehicle.

Here, ADAS may refer to various types of advanced driver assistance systems and may include, e.g., autonomous emergency braking (AEB) system, smart parking assistance system (SPAS), blind spot detection (BSD), adaptive cruise control (ACC), lane departure warning system (LDWS), lane keeping assist system (LKAS), and lane change assist system (LCAS). However, embodiments of the disclosure are not limited thereto.

The detector 110 may detect a frictional force between a road surface on which the vehicle is driving and a tire.

To that end, the detector 110 may include a plurality of frictional force sensors for detecting frictional force on each tire of the vehicle.

In an embodiment, the frictional force may mean an average of the frictional forces detected in each tire.

The producer 120 may produce a jerk plan for reaching a target location of the host vehicle based on the lateral jerk and the lateral acceleration of the host vehicle corresponding to the frictional force.

The jerk is a jerk in a lateral direction of the host vehicle, and may mean the amount of change in the lateral acceleration of the host vehicle for a predetermined time.

Accordingly, the jerk may be produced as the degree of lateral movement of the host vehicle.

The jerk plan is a plan for managing changes in acceleration, velocity, and location to make a smooth movement, and in the disclosure, a range in which the jerk and lateral acceleration of the host vehicle are set until the host vehicle reaches the target location may be set.

The jerk plan produces an optimal path until the target location is reached in order to make a smooth movement by considering the location and direction of the moving host vehicle and, for the jerk plan, the concept of geometry may be applied to planning the movement of the host vehicle.

Specifically, the producer 120 may be further configured to set a reference value that limits a size of the jerk and produce the jerk plan so that the jerk is within the reference value.

In other words, the producer 120 may produce a jerk plan that limits the size of the jerk in the direction of the jerk (right or left side of the host vehicle).

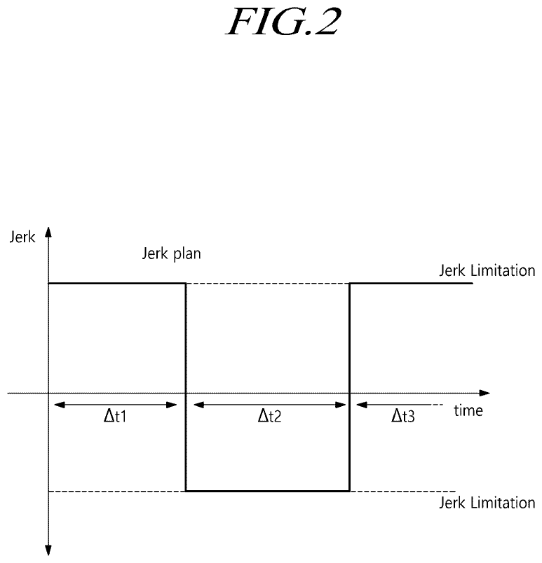

FIG. 2 is a view illustrating a jerk plan according to an embodiment.

Referring to FIG. 2, the producer 120 may be further configured to divide a period of time, which is expected to be required for moving of the host vehicle from the current location to the target location, into a plurality of sections, and set a jerk for each of the plurality of divided sections.

The producer 120 may set a reference value, jerk limitation, for limiting the size of the jerk. For example, in one section Δt1, the producer 120 may set the jerk at a value within the reference value, jerk limitation.

In an embodiment, the producer 120 may be further configured to produce a jerk plan, in which each jerk has the size of the reference value in the plurality of divided sections.

For example, in each section of Δt1, Δt2, and Δt3, a jerk having the same size as the reference value may be set for Δt1, and a jerk having the same size as the reference value but having an opposite direction may be set for Δt2.

Further, the producer 120 may set an acceleration reference value for the lateral acceleration to set a jerk plan so that the lateral acceleration has a value within the acceleration reference value.

As described above, the vehicle control device 10 according to the disclosure may limit the size of the jerk and the magnitude of the lateral acceleration to prevent the vehicle from slipping on the road surface to lose stability.

The producer 120 may be further configured to produce the jerk plan only when the host vehicle is required to avoid an object on the path, in moving to the target location.

Specifically, the jerk plan may be produced when an obstacle is detected on the driving path of the host vehicle so that it is determined that the host vehicle may not drive along the driving path.

Accordingly, the producer 120 may divide the time required for the host vehicle to reach the target location into a plurality of sections, and produce a jerk plan in which the jerk has the size of the reference value only for a section including a path through which the host vehicle avoids obstacles among the plurality of sections.

The jerk plan may be produced to take the shortest time for the host vehicle to reach the target location.

As described above, the vehicle control device 10 according to the disclosure may provide an optimal path for the host vehicle to reach a target location by generating a driving route using a jerk plan.

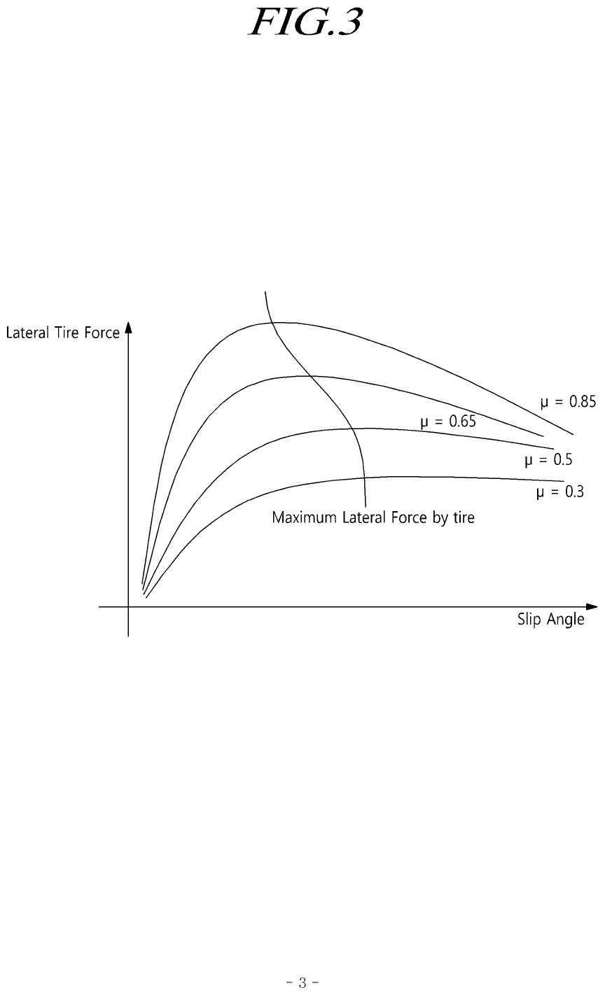

FIG. 3 is a view illustrating a lateral acceleration that varies depending on tire types according to an embodiment.

Referring to FIG. 3, the reference value may be set to differ depending on the type of tire of the host vehicle.

The frictional force of the tire may vary depending on the material or density of the tire, the area and pattern in which the tire touches the road surface, the structure of the tire, or the like.

Accordingly, the producer 120 may pre-store a table in which the lateral force corresponding to the slip angle of the mounted tire is stored, and set a reference value considering the detected frictional force and the pre-stored table.

As described above, the vehicle control device 10 according to the disclosure may produce a jerk plan more suitable for the driving circumstance by further considering the type of tire mounted on the vehicle.

The producer 120 may produce the jerk plan considering the current driving circumstance of the vehicle. In some embodiments, the producer 120 is a processor, which is a hardware.

Here, the current driving circumstance may include, e.g., the heading angle of the host vehicle, the current velocity of the host vehicle, the lateral distance of the host vehicle, the yaw rate of the host vehicle, the roll, the wheel slip, or the like.

The above-described driving circumstance may be detected from each sensor included in the detector 110, or information about the driving circumstance may be input from the outside.

The controller 130 may output a control signal to each actuator of the host vehicle, to move the host vehicle based on the jerk plan. In some embodiments, the controller 130 is a processor, which is a hardware.

Here, the actuator is not limited to a specific control device as long as it may affect driving of the host vehicle.

For example, the actuator may include a steering control device capable of front or rear wheel steering, a brake control device capable of partial braking, or the like.

The vehicle control device 10 may transmit and receive data to and from the above-described steering control device, brake control device, or the like through a controller area network (CAN) bus built in the vehicle. Accordingly, the control signal may include a steering control signal, a brake control signal, or the like.

The controller 130 may be further configured to input the produced jerk plan to a non-linear vehicle model, obtain a reference yaw rate from the non-linear vehicle model, and output a control signal according to the reference yaw rate.

Specifically, the jerk plan is used to smoothly and stably control the movement of the host vehicle, and may be applied as a control input of the non-linear vehicle model.

For example, the jerk plan may be used to manage acceleration, velocity, and location changes of the host vehicle and to plan an optimal driving path, and the non-linear vehicle model may produce a reference yaw rate for moving the host vehicle to a target location using the jerk plan and generate a control signal according to the reference yaw rate.

To that end, a jerk plan may be implemented using control theory and optimization techniques for non-linear systems.

In an embodiment, an autonomous vehicle model may be applied as the non-linear vehicle model.

As described above, the vehicle control device 10 according to the disclosure may provide an optimal path and movement of a vehicle to reach a target location and prevent impossible vehicle movement by calculating a reference yaw rate.

Further, the disclosure may provide a high turning capability considering a limit performance of each actuator in producing a path, by calculating a reference yaw rate where ADAS information may be effectively utilized in integrated control beyond the conventional single actuator.

Further, it is possible to apply a desired turning radius to the vehicle path to reach a target location by making a reference yaw rate after setting a reference value, rather than a method of setting a reference value after generating a reference yaw rate as conventional.

In an embodiment, the vehicle control device 10 may be implemented as, e.g., an electronic control unit (ECU).

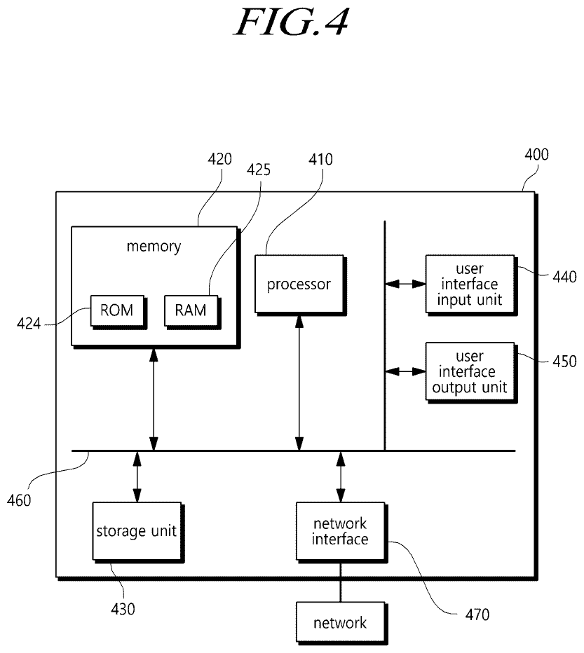

FIG. 4 is a block diagram illustrating a vehicle control device 10 according to another embodiment of the disclosure.

The above-described embodiments of the disclosure may be implemented as, e.g., a computer-readable recording medium, in a computer system.

Referring to FIG. 4, a computer system 400 such as the vehicle control device 10 may include at least one of one or more processors 410, a memory 420, a storage unit 430, a user interface input unit 440, and a user interface output unit 450, which may communicate with each other via a bus 460.

The computer system 400 may further include a network interface 470 for connecting to a network.

The processor 410 may be a central processing unit (CPU) or semiconductor device that executes processing instructions stored in the memory 420 and/or the storage unit 430.

The memory 420 and the storage unit 430 may include various types of volatile/non-volatile storage media. For example, the memory 1200 may include a read only memory (ROM) 424 and a random access memory (RAM) 425.

Described below is a vehicle control method using the vehicle control device 10 capable of performing the above-described embodiments of the disclosure.

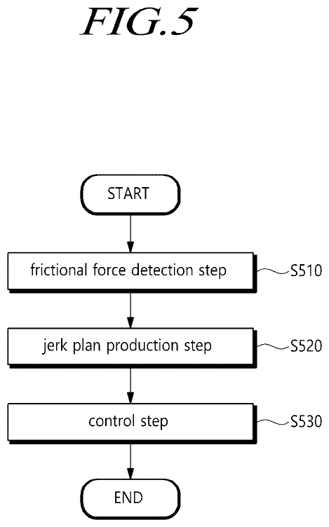

FIG. 5 is a flowchart illustrating a vehicle control method according to an embodiment of the disclosure.

Referring to FIG. 5, a vehicle control method according to an embodiment of the disclosure may comprise a frictional force detection step S510 detecting a frictional force between a road surface on which a host vehicle is driving and a tire, a jerk plan production step S520 producing a jerk plan for reaching a target location of the host vehicle based on a lateral jerk and a lateral acceleration of the host vehicle corresponding to the frictional force, and a control step S530 outputting a control signal to each actuator of the host vehicle, to move the host vehicle based on the jerk plan.

The frictional force detection step S510 may detect the average of the frictional forces between the road surface and each tire of the host vehicle.

The jerk plan production step S520 may include setting a reference value that limits the size of the jerk, and producing the jerk plan so that the jerk is within the reference value. Here, the reference value may be set to differ depending on the type of tire.

The jerk plan production step S520 may include dividing a period of time, which is expected to be required for moving of the host vehicle from the current location to the target location into a plurality of sections, and setting a jerk for each of the plurality of divided sections.

In an embodiment, the jerk plan production step S520 may include producing a jerk plan, in which the jerk of each of the plurality of divided sections has a size of the reference value.

The jerk plan production step S520 may produce the jerk plan only when the host vehicle is required to avoid an object on the path, in moving to the target location.

In an embodiment, the jerk plan production step S520 may produce the jerk plan so that the jerk has the size of the reference value only for a section having a path where the host vehicle avoids an obstacle among the plurality of sections described above.

The jerk plan may be produced to take the shortest time for the host vehicle to reach the target location.

The control step S530 may include inputting the jerk plan to a non-linear vehicle model, obtaining a reference yaw rate from the non-linear vehicle model, and outputting a control signal according to the reference yaw rate.

The actuator may include a steering control device and a brake control device, and the control signal may include a steering control signal that controls the steering of the host vehicle and a brake control signal that controls the braking force of the host vehicle.

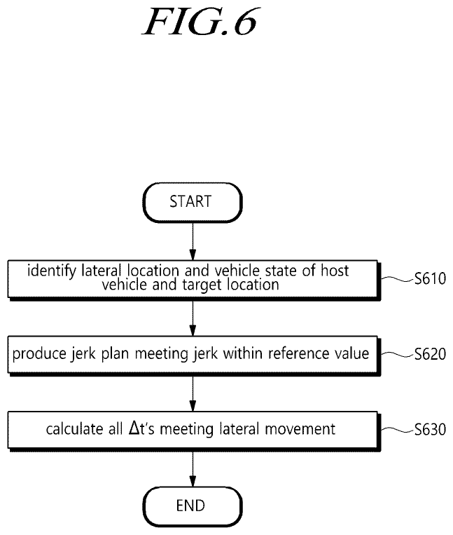

FIG. 6 is a flowchart illustrating, in greater detail, step S520 according to an embodiment.

Referring to FIG. 6, the vehicle control device 10 may identify the lateral location and vehicle state of the host vehicle and the target location (S610).

The vehicle control device 10 may receive sensing information from a plurality of sensors to determine the initial location and state of the host vehicle.

For example, the vehicle control device 10 may receive the lateral location and heading angle of the host vehicle from the radar sensor and receive steering angle information about the steering wheel from the steering angle sensor.

The vehicle control device 10 may detect the state of the road surface on which the host vehicle is driving and set a reference value.

For example, when it is determined that the road surface is wet due to rain, the vehicle control device 10 may set a low reference value.

The vehicle control device 10 may produce a jerk plan to meet a jerk within the reference value (S620).

The vehicle control device may set the reference value based on the jerk and lateral acceleration corresponding to the frictional force. Here, the reference value may mean a limit point to which the vehicle may move.

The vehicle control device 10 may calculate Δt to meet the lateral movement (S630).

The vehicle control device 10 may divide the time required until the host vehicle moves from the current location to the target location into a plurality of sections and produce a jerk within the reference value for each section.

The vehicle control device 10 may divide into the plurality of sections not to implement a movement impossible for the vehicle to make considering geometry.

For example, the vehicle control device 10 may divide a section including a path where an object is avoided and a section including a path where no obstacle is detected.

As another example, the vehicle control device 10 may divide the jerk value into a plurality of sections and calculate Δt as the time when the jerk value maintained the corresponding section.

As described above, according to the disclosure, the vehicle control device and method may make a desired turning radius for the host vehicle to reach a desired location by applying a reference value to a reference yaw rate.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims.

What is claimed:

1. A vehicle control device, comprising:
a detector configured to detect a frictional force between a road surface on which a host vehicle is driving and a tire;
a producer configured to produce a jerk plan for reaching a target location of the host vehicle based on a lateral jerk and a lateral acceleration of the host vehicle corresponding to the frictional force; and
a controller configured to output a control signal to each actuator of the host vehicle, to move the host vehicle based on the jerk plan.

2. The vehicle control device of claim 1, wherein the producer is further configured to set a reference value that limits a size of the jerk and produce the jerk plan so that the jerk is within the reference value.

3. The vehicle control device of claim 2, wherein the producer is further configured to divide a period of time, which is expected to be required for moving of the host vehicle from a current location of the host vehicle to the target location, into a plurality of sections, and set the jerk for each of the plurality of divided sections.

4. The vehicle control device of claim 3, wherein the producer is further configured to produce the jerk plan, in which the jerk of each of the plurality of divided sections has a size of the reference value.

5. The vehicle control device of claim 2, wherein the reference value is set to differ depending on a type of the tire.

6. The vehicle control device of claim 1, wherein the controller is further configured to input the jerk plan to a non-linear vehicle model, obtain a reference yaw rate from the non-linear vehicle model, and output the control signal according to the reference yaw rate.

7. The vehicle control device of claim 1, wherein the jerk plan is produced to control the host vehicle to reach the target location in a shortest time.

8. The vehicle control device of claim 1, wherein the control signal includes a steering control signal that controls steering of the host vehicle, and a brake control signal that controls a braking force of the host vehicle.

9. The vehicle control device of claim 1, wherein the detector is further configured to detect an average of the frictional force between the road and each tire of the host vehicle.

10. The vehicle control device of claim 1, wherein the producer is further configured to produce the jerk plan only when the host vehicle is required to avoid an object on a path, in moving to the target location.

11. A vehicle control method, comprising:
detecting a frictional force between a road surface on which a host vehicle is driving and a tire;
producing a jerk plan for reaching a target location of the host vehicle based on a lateral jerk and a lateral acceleration of the host vehicle corresponding to the frictional force; and
outputting a control signal to each actuator of the host vehicle, to move the host vehicle based on the jerk plan.

12. The vehicle control method of claim 11, wherein the producing the jerk plan comprises:
setting a reference value that limits a size of the jerk, and producing the jerk plan so that the jerk is within the reference value.

13. The vehicle control method of claim 12, wherein the producing the jerk plan further comprises:
dividing a period of time, which is expected to be required for moving of the host vehicle from a current location of the host vehicle to the target location, into a plurality of sections, and setting the jerk for each of the plurality of divided sections.

14. The vehicle control method of claim 13, wherein the producing the jerk plan further comprises:
producing the jerk plan, in which the jerk of each of the plurality of divided sections has a size of the reference value.

15. The vehicle control method of claim 12, wherein the reference value is set to differ depending on a type of the tire.

16. The vehicle control method of claim 11, wherein the controlling comprises:
inputting the jerk plan to a non-linear vehicle model;
obtaining a reference yaw rate from the non-linear vehicle model; and
outputting the control signal according to the reference yaw rate.

17. The vehicle control method of claim 11, wherein the jerk plan is produced to control the host vehicle to reach the target location in a shortest time.

18. The vehicle control method of claim 11, wherein the control signal includes a steering control signal that controls steering of the host vehicle and a brake control signal that controls a braking force of the host vehicle.

19. The vehicle control method of claim 11, wherein the detecting comprises:
detecting an average of the frictional force between the road and each tire of the host vehicle.

20. The vehicle control method of claim 11, wherein the producing the jerk plan comprises:
producing the jerk plan only when the host vehicle is required to avoid an object on a path, in moving to the target location.
